(19) United States
(12) Patent Application Publication
(10) Pub. No.: US 2010/0250103 A1
(43) Pub. Date: Sep. 30, 2010

(54) CONTROL OF INTERNAL COMBUSTION ENGINE

(75) Inventors: Daisuke Shimo, Hiroshima-shi (JP); Motoshi Kataoka, Hiroshima-shi (JP); Yoshihisa Nakamoto, Hiroshima-shi (JP); Tatsuya Tanaka, Higashihiroshima-shi (JP); Kota Maekawa, Hiroshima-shi (JP); Hideya Horii, Higashihiroshima-shi (JP); Takashi Hatano, Kure-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: MAZDA MOTOR CORPORATION, Hiroshima (JP)

(21) Appl. No.: 12/732,107

(22) Filed: Mar. 25, 2010

(30) Foreign Application Priority Data
Mar. 27, 2009 (JP) 2009-079534

(51) Int. Cl. F02D 41/00; F02M 25/07

(52) U.S. Cl. 701/108; 123/568.2; 123/568.21

(57) ABSTRACT

An exemplary method of controlling an internal combustion engine system is described herein. The internal combustion engine system includes an internal combustion engine, a valve driving mechanism which reciprocally drives an intake valve and an exhaust valve for a combustion chamber of the internal combustion engine, a turbocharger including a turbine and a compressor, and a first EGR passage which communicates an exhaust passage downstream of the emission control device and an intake passage upstream of the compressor. The exemplary method includes shutting off supplying fuel to the combustion chamber under a predetermined condition, and decreasing a lift of the intake or exhaust valve for the combustion chamber during the shutting off supplying fuel to the combustion chamber compared to in a case of supplying fuel to said combustion chamber.

### BACKGROUND

The present description relates to control of an internal combustion engine, and more particularly to control of exhaust gas recirculation (EGR) of the internal combustion engine.

There is well known exhaust gas recirculation in which a part of the exhaust gas is circulated from the exhaust passage through an EGR passage to the intake passage of an internal combustion engine, such as a diesel engine. The amount of the recirculated exhaust gas is controlled so as to decrease the oxygen concentration in the combustion chamber as long as the desired output is obtained and soot generation is permissible. It can suppress generation of nitrogen oxide that is generated when excessive oxygen combustion makes temperature and pressure in the combustion chamber too high.

In the meantime, to suppress the fuel consumption, there is known fuel cut control in which fuel supply to the combustion chamber is stopped when a predetermined condition is met, for example, when an engine speed is a predetermined speed or greater and a desired torque or a depression amount or an accelerator pedal of an automobile vehicle is zero. If the fuel supply is stopped when the exhaust gas is circulated through the EGR passage, combustion is stopped and fresh air is exhausted from the combustion chamber to the exhaust passage. The earlier combusted gas is going through the intake passage, the combustion chamber and the exhaust passage over time and comes out from the tail pipe. Finally, the combusted gas in the EGR passage is replaced with fresh air.

When the fuel supply is restarted in a situation where there is no combusted gas in the EGR passage, the fresh air in the EGR passage is supplied into the combustion chamber just after the restart of fuel supply and the combusted gas is recirculated sometime after the fuel supply is resumed. Therefore, until the combusted gas reaches the combustion chamber, the oxygen concentration is too high to suppress the NOx generation.

In a diesel engine which mixes air and fuel beforehand and compresses and ignites the pre-mixed air fuel mixture at desired timing, the ignition timing can be controlled by controlling oxygen concentration of air inducted into the combustion chamber by means of amount of the recirculated, combusted gas. However, if the recirculation of the combusted gas is delayed, as described above, the ignition may occur too early, leading to issues like too much combustion noise and decrease of output noise.

There is known and described, for example, in Japanese patent application publication no. 2007-138810, a method to address the problems described above. The publication discloses a system which comprises a turbocharger having a turbine arranged in the exhaust passage and a compressor arranged in the intake passage, an EGR passage which communicates the intake passage downstream of the compressor and the exhaust passage upstream of the turbine, an intake regulating valve arranged in the intake passage downstream of the compressor and upstream of its converging part with the EGR passage, and an exhaust regulating valve arranged in the exhaust passage downstream of the turbine. The method closes the intake regulating valve and the exhaust regulating valve so as to regulate the combusted gas from flowing out when the fuel supply is stopped. Therefore, the prior method can supply the recirculated, combusted gas into the combustion chamber when the fuel supply is resumed.

However, the prior method may cause some problems if it is applied to a system having a so called low pressure EGR passage which communicates the intake passage upstream of the compressor and the exhaust passage downstream of an emission control device such as a catalytic converter which is further downstream of the turbine to circulate lower temperature combusted gas. The lower temperature of the circulated, combusted gas causes the duration between fuel injection and its ignition to be longer. This longer duration enables the air and fuel to be mixed more to produce more output torque.

Specifically, the fuel supply is shut off, the combusted gas is circulated from the exhaust passage downstream of the emission control device through the low pressure EGR passage to the intake passage upstream of the compressor, and then the engine inducts and pumps out the circulated gas to the exhaust passage. This cycle continues until the fuel supply is resumed. Therefore, the circulated gas continues flowing through and taking heat from the emission control device. It may lead to cooling the emission control device during the fuel shutoff and deteriorating the emission control performance at the time of fuel resumption.

Therefore, there is room for improvement of the emission control performance at the time of fuel resumption.

### SUMMARY

The inventors herein have rigorously studied to improve emission control performance at the time of fuel resumption and unexpectedly found a method to control an internal combustion engine system which solves disadvantages of the prior method and presents further advantages.

Accordingly, there is provided, in one aspect of the present description, a method of controlling an internal combustion engine system having an internal combustion engine, a valve driving mechanism which reciprocally drives intake and exhaust valves for a combustion chamber of the internal combustion engine with rotational movement of a crankshaft of the internal combustion engine, a turbocharger consisting of a turbine which is arranged in an exhaust passage from a combustion chamber of the internal combustion engine and a compressor which is arranged in an intake passage to the combustion chamber, an emission control device which is arranged in the exhaust passage downstream of the turbine, a first EGR passage which communicates the exhaust passage downstream of the emission control device and the intake passage upstream of the compressor. The method comprises shutting off supplying fuel to the combustion chamber under a predetermined condition, and decreasing a lift of the intake or exhaust valve for the combustion chamber during shutting off supplying fuel to the combustion chamber compared to in a case of supplying fuel to the combustion chamber.

According to the first aspect, by decreasing a lift of the intake or exhaust valve for the combustion chamber during the shutting off supplying fuel to the combustion chamber, a gas flow from the intake passage through the combustion chamber to the exhaust passage is restricted, and accordingly the gas flow through the first EGR passage is restricted. Therefore, more of the gas combusted prior to the fuel shut off stays in a circulation path of the combusted gas which goes from the exhaust passage through the first EGR passage and the intake passage to the combustion chamber during the fuel shut off. As a result, when the fuel supply is resumed, the greater amount of the combusted gas which has stayed in the circulation path can be promptly introduced into the combustion chamber.

And, less of the combusted gas flows through the emission control device, even though it is arranged in the circulation path. Therefore, the temperature of the emission control device falls less during the fuel shut off and increases the emission control performance at the time of fuel resumption.

Further, there is no need to arrange a valve downstream of the turbine in order to restrict the gas flow through the circulation path. Therefore, less of a pressure wave, which is generated when the exhaust valve opens, reflects and returns to the turbine. As a result, durability and reliability of the turbine can be improved.

In some embodiments, the internal combustion engine system may further have an intake regulating valve which is arranged in the intake passage upstream of its connection with the first EGR passage. And, the method may further comprise decreasing an opening of the intake regulating valve during the shutting off supplying fuel to the combustion chamber compared to in a case of supplying fuel to the combustion chamber. Accordingly, during the fuel shut off, less fresh air is inducted and the combusted gas in the circulation path is less diluted. Therefore, at the time of the fuel resumption, an ideal amount of the combusted gas can be supplied into the combustion chamber.

Further, in some embodiments, the internal combustion engine system may further have a first EGR control valve which is arranged in the first EGR passage and configured to control gas flow through the first EGR passage. The method may further comprise decreasing an opening of the first EGR control valve during the shutting off supplying fuel to the combustion chamber compared to in a case of supplying fuel to the combustion chamber. Accordingly, during the fuel shut off, gas flow in the first EGR passage is restricted and more of the combusted gas stays in the EGR passage.

Further, in some embodiments, a lift of either one of the intake and exhaust valves for the combustion chamber may be decreased during the shutting off supplying fuel to the combustion chamber. One of the intake and exhaust valves operates changed (for example, operation of the intake valve is stopped or its lift is decreased to zero), while another one of intake and exhaust valve operates unchanged. This causes imbalance of a pressure in the cylinder between intake and exhaust strokes, leading to a pumping loss that can be useful to brake the engine and eventually a vehicle it drives.

Further, in some embodiments, the internal combustion engine system may further have a second EGR passage which communicates the exhaust passage upstream of the turbine and the intake passage downstream of the compressor, and a second EGR control valve which is arranged in the second EGR passage and configured to control gas flow through the second EGR passage. The method may further comprise increasing an opening of the second EGR control valve during the shutting off supplying fuel to the combustion chamber compared to in a case of supplying fuel to the combustion chamber, and decreasing the lift of the intake valve during the shutting off supplying fuel to the combustion chamber. Accordingly, even if the lift of the exhaust valve is not decreased to generate more pumping loss, the pressure wave generated when the exhaust valve opens can be transmitted through the second EGR passage and attenuated before reaching the turbine. Therefore, it can improve the durability and reliability of the turbine while increasing the braking effect of the engine.

Still further, in some embodiments, the internal combustion engine system may further have a flow control valve which controls flow rate of gas flowing through the exhaust passage to the turbine. The method may further comprise decreasing a flow rate of gas flowing to the turbine by means of the flow control valve during the shutting off supplying fuel to the combustion chamber compared to in a case of supplying fuel to the combustion chamber, and decreasing the lift of the intake valve during the shutting off supplying fuel to the combustion chamber. Accordingly, even if the lift of the exhaust valve is not decreased to generate more pumping loss, the gas flow rate to the turbine is decreased and the pressure wave generated when the exhaust valve opens can be weakened. Therefore, it can improve the durability and reliability of the turbine while increasing the braking effect of the engine.

### BRIEF DESCRIPTION OF THE DRAWINGS

FIG. 1 is a schematic configuration view of a diesel engine and an intake-and-exhaust system thereof according to an embodiment of the present invention.

FIG. 2 is a schematic block diagram of a control system including a control device of the diesel engine of this embodiment.

FIG. 3 is a graph showing a map for determining an EGR passage to be used, based on an engine speed and an engine load.

FIG. 4 is a timing chart showing a change in an opening of each valve based on a fuel cut.

FIG. 5 is a flowchart showing a control of each valve based on the fuel cut.

### DESCRIPTION OF EMBODIMENT

Hereinafter, an embodiment of the present invention is described referring to the appended drawings.

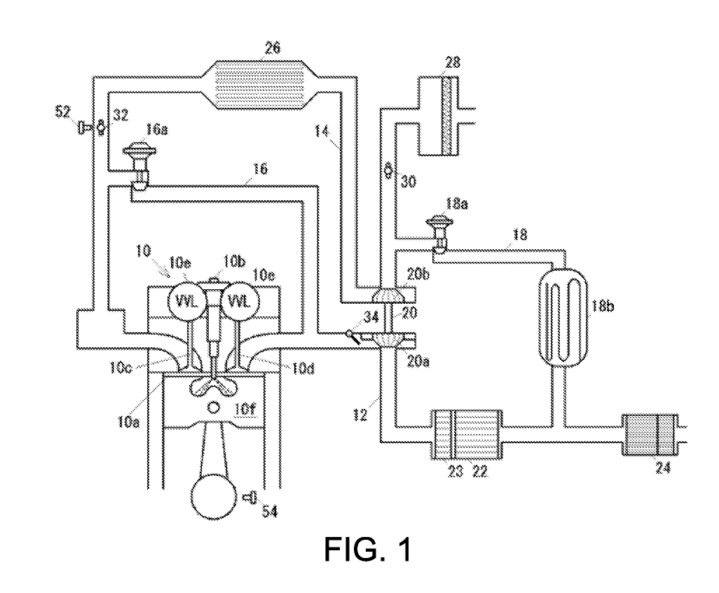

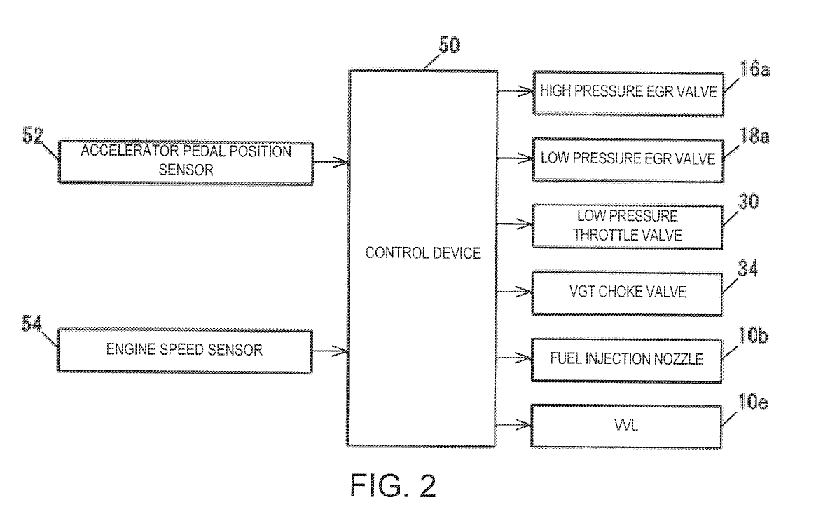

FIG. 1 schematically shows a configuration of a diesel engine 10 and its intake-and-exhaust system according to an embodiment of the present invention. FIG. 2 shows a control system of the diesel engine.

The diesel engine 10 shown in FIG. 1 recirculates a part of exhaust gas from an exhaust passage 12 to an intake passage 14. In order to circulate the exhaust gas, the engine is provided with a high pressure EGR passage 16 (corresponding to a “second EGR passage” in the claims) and a low pressure EGR passage 18.

The diesel engine 10 also includes an exhaust turbocharger 20, and its turbine 20a is arranged in the exhaust passage 12 and a compressor 20b is arranged in the intake passage 14.

The high pressure EGR passage 16 communicates a part of the exhaust passage 12 upstream of the turbine 20a of the exhaust turbocharger 20 with a part of the intake passage 14 downstream of the compressor 20b. The high pressure EGR passage 16 is provided with a high pressure EGR valve 16a for adjusting a recirculating amount of exhaust gas which passes through the passage 16 (EGR amount).

The low pressure EGR passage 18 communicates a part of the exhaust passage 12 downstream of the turbine 20a of the exhaust turbocharger 20 with a part of the intake passage 14 upstream of the compressor 20b. The low pressure EGR passage 18 is provided with a low pressure EGR valve 18a for adjusting an EGR amount of exhaust gas which passes through the passage 18, and an EGR cooler 18b for cooling the recirculated exhaust gas.

The diesel engine 10 includes, in the exhaust passage 12, specifically in the part of the exhaust passage 12 between the turbine 20a of the turbocharger 20 and the low pressure EGR passage 18, a particulate filter 22 for capturing soot in exhaust gas, an oxidation catalyst 23 provided upstream of the particulate filter 22 and for oxidizing hydrocarbon and the like in the exhaust gas with oxygen in the exhaust gas, a lean NOx trap catalyst (hereinafter, referred to as a “NOx catalyst”) 24 provided in the part of the exhaust passage 12 downstream of the low pressure EGR passage 18 and for suppressing discharge of NOx in the exhaust gas to the exterior by processing (trapping) NOx. Note that the particulate filter 22 and the oxidation catalyst 23 constitute an “emission control device” in the claims.

The diesel engine 10 is also provided with an intercooler 26 for cooling intake air, which is provided in a part of the intake passage 14 between the compressor 20b of the turbocharger 20 and the high pressure EGR passage 16. The diesel engine 10 is also provided with an air cleaner 28 for cleaning the intake air, which is provided in a part of the intake passage 14 upstream of the low pressure EGR passage 18.

Further, the diesel engine 10 is provided with a low pressure throttle valve 30, which is provided in a part of the intake passage 14 between the low pressure EGR passage 18 and the air cleaner 28. The diesel engine 10 is also provided with a high pressure throttle valve 32, which is provided in a part of the intake passage 14 between the high pressure EGR passage 16 and the intercooler 26. Further, the diesel engine 10 is provided with a choke valve (hereinafter, referred to as a “VGT (Variable Geometry Turbine) choke valve”) 34 for adjusting a flow velocity of exhaust gas to the turbine 20a of the turbocharger 20.

The low pressure throttle valve 30 is a valve for adjusting a pressure upstream of the compressor 20b of the intake passage 14, and adjusts a flow of fresh air into the intake passage 14 by controlling an opening thereof. When the opening of the low pressure throttle valve 30 is adjusted, a pressure in a part of the intake passage 14 between the valve 30 and the compressor 20b is adjusted; thereby this pressure adjustment adjusts an amount of exhaust gas which flows from the exhaust passage 12 toward the intake passage 14 via the low pressure EGR passage 18.

The high pressure throttle valve 32 is a valve for adjusting an amount of intake air supplied to a combustion chamber 10a of the diesel engine 10, and if a depression amount of an accelerator pedal by a driver increases, the valve 32 is fundamentally controlled so that its opening becomes greater. That is, this opening corresponds to a load of the diesel engine 10.

The VGT choke valve 34 is provided in a part of the exhaust passage 12 upstream of the turbine 20a, and by adjusting its opening (choke amount), it adjusts a flow velocity of exhaust gas to the turbine 20a, that is, it adjusts a rotation speed of the turbine 20a, that is, it adjusts a pressure ratio of the compressor of the exhaust turbocharger 20.

In addition, the diesel engine 10 equips a variable valve lift mechanism (hereinafter, referred to as a “VVL”) 10e which adjusts lifts of an intake valve 10c and an exhaust valve 10d. The VVL 10e can adjust each lift of the intake valve 10c and the exhaust valve 10d so that they are in a fully-closed state or a substantially fully-closed state.

As shown in FIG. 2, a control device 50 of such a diesel engine 10 performs various controls to the high pressure EGR valve 16a, the low pressure EGR valve 18a, the low pressure throttle valve 30, the VGT choke valve 34, a fuel injection nozzle 10b, and the VVL 10e based on signals from an accelerator pedal position sensor 52 for detecting the depression amount of the accelerator pedal and an engine speed sensor 54 for detecting a rotation speed of the diesel engine 10.

First, the control device 50 determines a total EGR amount which recirculates to the combustion chamber 10a of the diesel engine 10 (the sum of an EGR amount through the high pressure EGR passage 16 and an EGR amount through the low pressure EGR passage 18) based on the signals from the engine speed sensor 54 and the accelerator pedal position sensor 52, that is, based on an engine speed N and an engine load L.

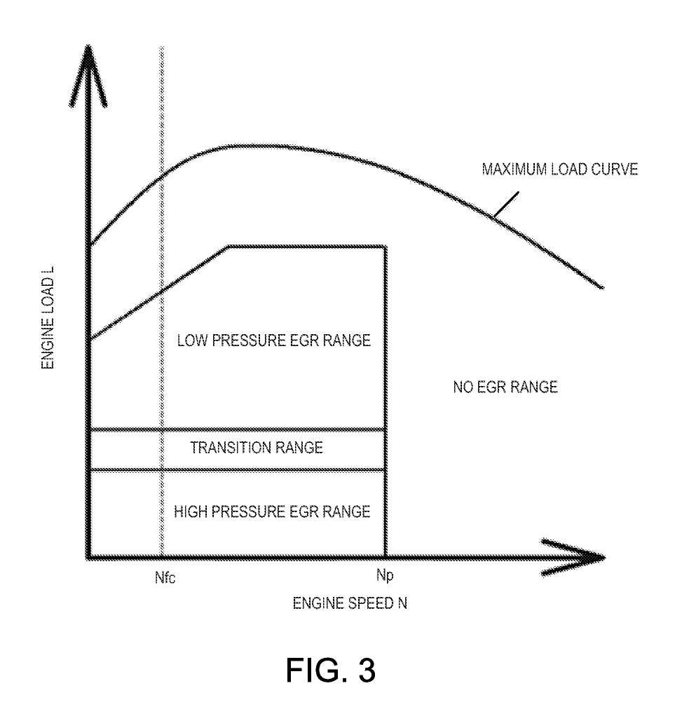

Specifically, the total EGR amount is determined by using a map shown in FIG. 3. When the engine speed N exceeds a predetermined engine speed Np, the control device 50 does not recirculate exhaust gas to the combustion chamber 10a of the diesel engine 10 (the high pressure EGR valve 16a and the low pressure EGR valve 18a are closed). This is because, if the exhaust gas is recirculated to the combustion chamber 10a when the engine speed exceeds Np, an oxygen amount in the combustion chamber 10a will be insufficient and more smoke than a criterion value will occur.

When the engine speed N does not exceed Np and the engine load L is low, the control device 50 causes exhaust gas to recirculate to the combustion chamber 10a of the diesel engine 10 only via the high pressure EGR passage 16 (the low pressure EGR valve 18a is closed). On the other hand, when the engine load L is high, it causes exhaust gas to recirculate only via the low pressure EGR passage 18 (the high pressure EGR valve 16a is closed). Note that, when the engine load is in between (in a case of a transition range), exhaust gas is recirculated via both the EGR passages.

More specifically, because the exhaust gas which recirculates to the combustion chamber 10a via the low pressure EGR passage 18 will be cooled by the EGR cooler 18b and the intercooler 26, a temperature of the exhaust gas is lower compared with exhaust gas that recirculates via the high pressure EGR passage 16 (that is, a density is higher). Therefore, when the engine load L is high, in order to attain an output under the load (i.e., in order to increase the oxygen amount in the combustion chamber 10a), the exhaust gas through the low pressure EGR passage 18 is recirculated to the combustion chamber 10a. On the other hand, when the engine load L is low, because the oxygen amount in the combustion chamber 10a can be less compared with the case where the load is high, the exhaust gas through the high pressure EGR passage 16 is recirculated to the combustion chamber 10a.

When the exhaust gas is recirculated through either the high pressure EGR passage 16 or the low pressure EGR passage 18, the control device 50 calculates the total EGR amount based on the engine speed N and the engine load L, that is, based on an output of the diesel engine 10. In other words, a minimum oxygen amount in the combustion chamber 10a is calculated so that the output can be attained and the amount of smoke generated does not worsen past the criterion value. Then, the openings of the EGR valve 16a and/or 18a, the low pressure throttle valve 30, and the high pressure throttle valve 32 are suppressed so that they achieve the calculated oxygen amount. Thereby, the oxygen concentration in the combustion chamber 10a is reduced to suppress the generation of NOx while securing a required output of the diesel engine 10.

Moreover, the control device 50 controls the opening of the low pressure throttle valve 30 and the opening of the VGT choke valve 34 based on the engine speed N and the engine load L, that is, based on the output of the diesel engine 10. For example, when the engine load L is high, in order to increase the oxygen amount in the combustion chamber 10a, the opening of the low pressure throttle valve 30 is increased, and the opening of the VGT choke valve 34 is decreased (increasing the choke amount). Thereby, the rotation speed of the turbine 30a of the exhaust turbocharger 20 is increased, and the pressure ratio by the compressor 20b of the exhaust turbocharger 20 is increased.

Further, the control device 50 shuts off fuel supply to the combustion chamber 10a from the fuel injection nozzle 10b, when the depression amount detected by the accelerator pedal position sensor 52 is zero (the engine load L is zero) and the engine speed N detected by the engine speed sensor 54 is greater than a predetermined speed Nfc, by the control device 50 determining that a fuel cut condition (corresponding to a “predetermined condition” in the claims) is met. This suppresses fuel consumption.

During the shut-off of fuel supply (during the fuel cut), the control device 50 controls the VVL 10e, the low pressure EGR valve 18a, the low pressure throttle valve 30, the high pressure EGR valve 16a, and the VGT choke valve 34 so that the exhaust gas can be recirculated to the combustion chamber 10a immediately when the fuel supply is resumed.

More specifically, the control device 50 controls the VVL 10e during the fuel cut to stop the intake valve 10c at the fully-closed state. Note that the exhaust valve 10d is operated while being in a state before the fuel cut.

Thereby, the flow of exhaust gas from the intake passage 14 to the exhaust passage 12 via the combustion chamber 10a is restricted (stopped). In addition, the flow of exhaust gas in the exhaust passage 12, the low pressure EGR passage 18, and the intake passage 14, that is, the flow of exhaust gas in a low pressure recirculating route of the exhaust gas is restricted. As a result, the exhaust gas in the exhaust passage 12, the low pressure EGR passage 18, and the intake passage 14 stay therein during the fuel cut. Then, when the fuel supply is resumed, the exhaust gas stayed in the exhaust passage 12, the low pressure EGR passage 18, and the intake passage 14 immediately recirculates to the combustion chamber 10a.

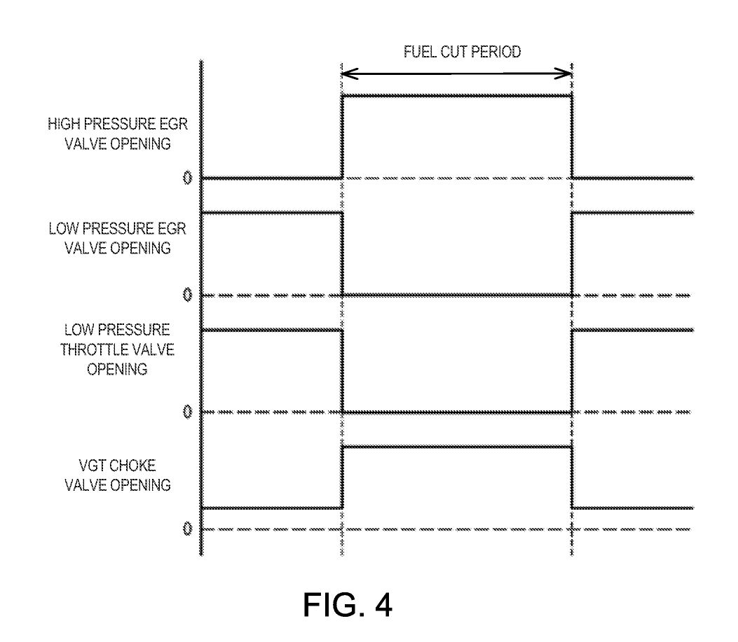

As shown in FIG. 4, the control device 50 also controls the low pressure EGR valve 18a to be in the fully-closed state during the fuel cut. Note that FIG. 4 is a timing chart showing changes in openings of the high pressure EGR valve 16a, the low pressure EGR valve 18a, the low pressure throttle valve 30, and the VGT choke valve 34 when the fuel cut is performed during an operation in the low pressure EGR range of FIG. 3. By making the low pressure EGR valve 18a into the fully-closed state, the flow of exhaust gas in the low pressure EGR passage 18 is restricted during the fuel cut.

During the fuel cut, the control device 50 also controls the low pressure throttle valve 30 into the fully-closed state as shown in FIG. 4. During the fuel cut, when the low pressure throttle valve 30 is made into the fully-closed state, the inflow of fresh air will be lost and dilution of the exhaust gas in the intake passage 14 will be suppressed. As described later in more detail, because the high pressure EGR valve 16a is in the fully-open state, the dilution of exhaust gas in the high pressure EGR passage 16, the exhaust passage 12, and the low pressure EGR passage 18 is also suppressed. As a result, after the resumption of fuel supply, exhaust gas with suitable concentration is sufficiently supplied and generation of NOx can certainly be suppressed.

In addition, during the fuel cut, the control device 50 positions the high pressure EGR valve 16a into the fully-open state, and controls the VGT choke valve 34 into the fully-open state (the choke amount is zero), as shown in FIG. 4. This is for suppressing a reverse rotation of the turbine 20a of the exhaust turbocharger 20.

More specifically, because only the exhaust valve 10e operates in the diesel engine 10 during the fuel cut, pressure pulsation is generated in the exhaust passage 12. When the pressure pulsation occurs in the exhaust passage 12, the turbine 20a, which is configured so that it rotates by a flow in a direction from the combustion chamber 10a to the outside (exhaust outlet), periodically rotates in the reverse direction, and as a result, the reliability of the exhaust turbocharger 20 will fall.

In order to address this situation, if the high pressure EGR valve 18a is made into the fully-open state, exhaust gas upstream of the turbine 20a flows into the intake passage 14 via the high pressure EGR passage 16. That is, because the pressure pulsation in the exhaust passage 12 is transmitted to the high pressure EGR passage 16 and attenuated, the pressure pulsation which acts on the turbine 20a is suppressed.

If the VGT choke valve 34 is made into the fully-open state, because the flow velocity of the exhaust gas which rotates the turbine 20a will be low, the pressure pulsation which acts on the turbine 20a is suppressed.

The reliability of the turbocharger 20 can be maintained by these processes.

Note that, as described above, if the intake valve 10c is stopped in the fully-closed state during the fuel cut and the exhaust valve 10d are operated in a state before the fuel cut, engine braking ability will be enhanced as a secondary effect (large engine braking occurs).

More specifically, if the intake valve 10c is stopped in the fully-closed state, air is not introduced in an intake stroke to generate a negative pressure in the combustion chamber 10a to generate a resisting force against vehicle traveling. Further, in a compression stroke, that negative pressure pulls up a piston 10f to generate a traveling motive force, and in an expansion stroke, negative pressure is again generated to generate a resisting force against vehicle traveling, and in an exhaust stroke, because the exhaust valve 10d is opened, neither the resisting force nor the motive force is generated. Therefore, a resisting force against vehicle traveling occurs as total. That is, a large amount of engine braking occurs.

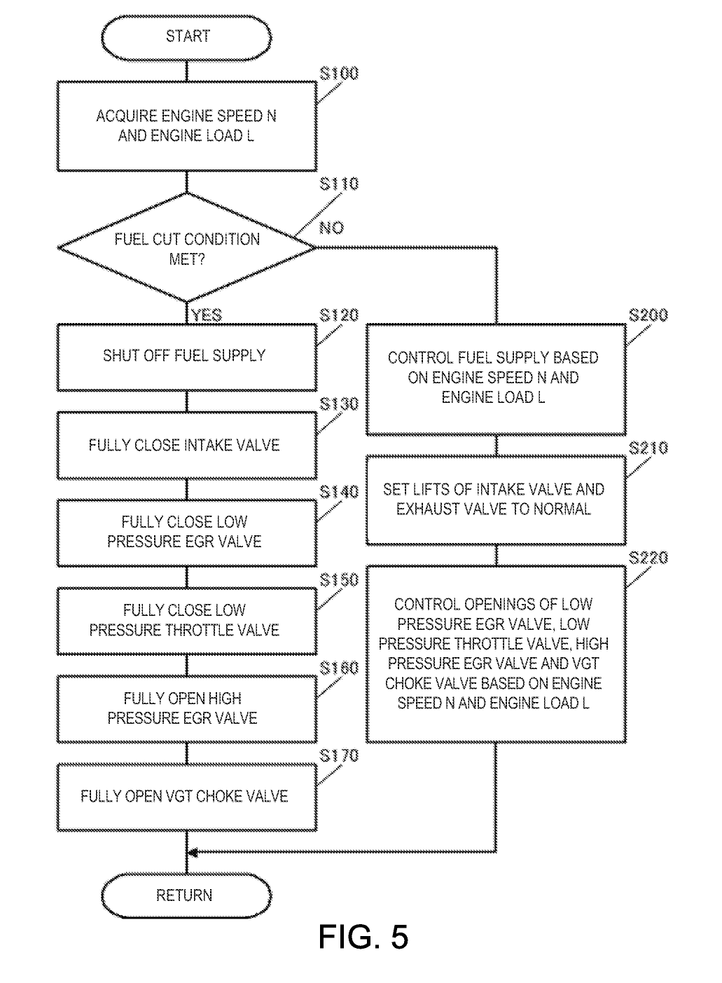

Below, processing of the control performed by the control device 50 is described referring to a flowchart shown in FIG. 5.

First, at Step S100, the control device 50 acquires the engine speed N and the engine load L of the diesel engine 10 based on the signals from the accelerator pedal position sensor 52 and the engine speed sensor 54.

At Step S110, the control device 50 determines whether the condition to cut fuel is met, that is, whether the engine speed N is greater than the predetermined speed Nfc and the engine load L is zero, based on the engine speed N and the engine load L which are acquired at Step S100. When the fuel cut condition is met, the control device 50 proceeds to Step S120, and otherwise, the control device 50 proceeds to Step S200.

At Step S120, the control device 50 controls the fuel injection nozzle 10b to shut off the fuel supply to the combustion chamber 10a.

At Step S130, the control device 50 controls the VVL 10e to stop the intake valve 10c in the fully-closed state.

At Step S140, the control device 50 controls the low pressure EGR valve 18a into the fully-closed state.

At Step S150, the control device 50 controls the low pressure throttle valve 30 into the fully-closed state.

At Step S160, the control device 50 controls the high pressure EGR valve 18a into the fully-open state.

At Step S170, the control device 50 controls the VGT choke valve 34 into the fully-open state (the choke amount is zero). Then, the control device 50 returns to the start of the process at S100.

On the other hand, when the control device 50 determines that the fuel cut condition is not met at Step S110, the control device 50 controls the fuel supply based on the engine speed N and the engine load L at Step S200.

At Step S210, the control device 50 controls the VVL 10e to set the lifts of the intake valve 10c and the exhaust valve 10d to normal (the intake valve 10c and the exhaust valve 10d are operated by normal lifts).

At Step S220, the control device 50 controls the low pressure EGR valve 18a, the low pressure throttle valve 30, the high pressure EGR valve 16a, and the VGT choke valve 34 based on the engine speed N and the engine load L. Then, the control device 50 returns to the start of the process at S100.

According to this embodiment, by making the intake valve 10c of the diesel engine 10 into the fully-closed state during the fuel cut, the flow of exhaust gas which reaches the exhaust passage 12 from the intake passage 14 via the combustion chamber 10a is restricted, and accordingly, the flow of exhaust gas in the low pressure EGR passage 18 is also suppressed. Therefore, the exhaust gas which existed in a recirculating route of the exhaust gas which flows from the combustion chamber 10a and returns to the combustion chamber 10a through the exhaust passage 12, the low pressure EGR passage 18, and the intake passage 14 before the fuel cut stays in this route during the fuel cut.

Therefore, a flow rate of the exhaust gas which flows through the particulate filter 22 and the oxidation catalyst 23 is restricted. As a result, an amount of heat radiated from the emission control device during the fuel cut decreases, a temperature of the emission control device is maintained, and an exhaust purification performance at the time of resumption of the fuel supply is maintained.

Further, because the low pressure EGR passage 18 is provided between a part of the exhaust passage 12 downstream of the turbine 20a of the turbocharger 20 and a part of the intake passage 14 upstream of the compressor 20b, the recirculating route of exhaust gas is elongated. Thereby, because the staying amount of exhaust gas during the fuel cut is large, the exhaust gas can be recirculated to the combustion chamber 10a indefatigably for a long period of time from the start of the resumption of fuel supply. Therefore, generation of a period where the exhaust gas does not recirculate to the combustion chamber 10a temporarily after the resumption of fuel supply is suppressed.

Although the flow of exhaust gas which reaches the exhaust passage 12 from the intake passage 14 via the combustion chamber 10a is restricted, because the exhaust gas in the exhaust passage 12 can flow into the intake passage 14 via the low pressure EGR passage 18, pressure pulsation produced in the exhaust passage 12 is small. Therefore, no large force is generated that could rotate the turbine 20a in the reverse direction. As a result, the reliability of the turbocharger 20 is maintained.

As described above, although the present invention is described referring to this embodiment, the present invention is not limited to the configuration and function of this embodiment.

For example, in this embodiment, a valve which stops in the fully-closed state during the fuel cut is the intake valve 10c; however, the valve may be the exhaust valve 10d. In this case, even if the exhaust valve 10d stops in the fully-closed state, the flow of exhaust gas from the intake passage 14 to the exhaust passage 12 via the combustion chamber 10a can be restricted. In addition, large engine braking can be generated.

However, the generating mechanism of the large engine braking differs.

Specifically, when the exhaust valve 10d stops in the fully-closed state, because the intake valve 10c opens in an intake stroke, neither the resisting force nor the motive force is generated. In a compression stroke, the resisting force occurs by compressing air, and in an expansion stroke, the piston 10f is pressed down by the air compressed in the compression stroke to generate the motive force, and in an exhaust stroke, air cannot be discharged and the resisting force is generated by compressing the air. Therefore, the resisting force against vehicle traveling, that is, a large engine braking, occurs as total.

Further, in this embodiment, although the intake valve 10c is stopped in the fully-closed state during the fuel cut; however, it is not limited to this, and at least one of the lifts of the intake valve 10c and the exhaust valve 10d may be made smaller compared with the case the fuel cut is not carried out. Similarly, a flow of exhaust gas from the intake passage 14 to the exhaust passage 12 via the combustion chamber 10a may be restricted during the fuel cut.

Furthermore, in this embodiment, as shown in FIG. 4, the low pressure EGR valve 18a is controlled into the fully-closed state during the fuel cut; however, it is not limited to this, and the opening of the valve 18a may be made smaller compared with the case where the fuel cut is not carried out. Similarly, a flow of exhaust gas in the low pressure EGR passage 18 may be restricted.

Furthermore, in this embodiment, as shown in FIG. 4, the low pressure throttle valve 30 is controlled into the fully-closed state during the fuel cut; however, it is not limited to this, and the opening of the valve 30 may be made smaller compared with the case where the fuel cut is not carried out. Note that the valve may preferably be made into the fully-closed state so that dilution of the exhaust gas due to a flow of fresh air into the intake passage 14 can be suppressed.

In addition, in this embodiment, as shown in FIG. 4, the high pressure EGR valve 16a is controlled into the fully-open state during the fuel cut; however, it is not limited to this, and the opening of the valve 16a may be made larger compared with the case where the fuel cut is not carried out. Note that the valve 16a may preferably be made into the fully-open state because the pressure pulsation which acts on the turbine 20a of the exhaust turbocharger 20 can be suppressed.

In addition, in this embodiment, as shown in FIG. 4, the VGT choke valve 34 is controlled into the fully-open state (the choke amount is zero) during the fuel cut; however, it is not limited to this, and the opening of the valve 34 may be made larger (the choke amount is smaller) compared with the case where the fuel cut is not carried out. Note that the valve 34 may preferably be made into the fully-open state (the choke amount is zero) so that the pressure pulsation which acts on the turbine 20a of the exhaust turbocharger 20 can be suppressed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of controlling an internal combustion engine system having an internal combustion engine, a valve driving mechanism which reciprocally drives an intake valve and an exhaust valve for a combustion chamber of said internal combustion engine with rotational movement of a crankshaft of said internal combustion engine, a turbocharger consisting of a turbine which is arranged in an exhaust passage from a combustion chamber of said internal combustion engine and a compressor which is arranged in an intake passage to said combustion chamber, an emission control device which is arranged in said exhaust passage downstream of said turbine, a first EGR passage which communicates said exhaust passage downstream of said emission control device and said intake passage upstream of said compressor, and the method comprising:
shutting off supplying fuel to said combustion chamber under a predetermined condition; and
decreasing a lift of said intake or exhaust valve for said combustion chamber during said shutting off supplying fuel to said combustion chamber compared to in a case of supplying fuel to said combustion chamber.

2. The method as described in claim 1, wherein said internal combustion engine system further has an intake regulating valve which is arranged in said intake passage upstream of its connection with said first EGR passage, the method further comprising decreasing an opening of said intake regulating valve in said shutting off supplying fuel to said combustion chamber compared to in a case of supplying fuel to said combustion chamber.

3. The method as described in claim 2, wherein said internal combustion engine system further has a first EGR control valve which is arranged in said first EGR passage and configured to control gas flow through said first EGR passage, the method further comprising decreasing an opening of said first EGR control valve in said shutting off supplying fuel to said combustion chamber compared to in a case of supplying fuel to said combustion chamber.

4. The method as described in claim 3, wherein a lift of either one of said intake and exhaust valves for said combustion chamber is decreased in said shutting off supplying fuel to said combustion chamber.

5. The method as described in claim 4, wherein the lift of said either one of said intake and exhaust valves is decreased to zero in said shutting off supplying fuel to said combustion chamber.

6. The method as described in claim 5, wherein said internal combustion engine system further has a second EGR passage which communicates said exhaust passage upstream of said turbine and said intake passage downstream of said compressor, and a second EGR control valve which is arranged in said second EGR passage and configured to control gas flow through said second EGR passage, the method further comprising increasing an opening of said second EGR control valve in said shutting off supplying fuel to said combustion chamber compared to in a case of supplying fuel to said combustion chamber, and decreasing the lift of said intake valve in said shutting off supplying fuel to said combustion chamber.

7. The method as described in claim 6, wherein the internal combustion engine system further has a flow control valve which controls flow rate of gas flowing through said exhaust passage to said turbine, the method further comprising decreasing a flow rate of gas flowing to said turbine by means of said flow control valve in said shutting off supplying fuel to said combustion chamber compared to in a case of supplying fuel to said combustion chamber, and decreasing the lift of said intake valve in said shutting off supplying fuel to said combustion chamber.

8. The method as described in claim 1, wherein said internal combustion engine system further has a first EGR control valve which is arranged in said first EGR passage and configured to control gas flow through said first EGR passage, the method further comprising decreasing an opening of said first EGR control valve in said shutting off supplying fuel to said combustion chamber compared to in a case of supplying fuel to said combustion chamber.

9. The method as described in claim 8, wherein a lift of either one of said intake and exhaust valves for said combustion chamber is decreased in said shutting off supplying fuel to said combustion chamber.

10. The method as described in claim 9, wherein the lift of said either one of said intake and exhaust valves is decreased to zero in said shutting off supplying fuel to said combustion chamber.

11. The method as described in claim 10, wherein said internal combustion engine system further has a second EGR passage which communicates said exhaust passage upstream of said turbine and said intake passage downstream of said compressor, and a second EGR control valve which is arranged in said second EGR passage and configured to control gas flow through said second EGR passage, the method further comprising increasing an opening of said second EGR control valve in said shutting off supplying fuel to said combustion chamber compared to in a case of supplying fuel to said combustion chamber, and decreasing the lift of said intake valve in said shutting off supplying fuel to said combustion chamber.

12. The method as described in claim 11, wherein the internal combustion engine system further has a flow control valve which controls flow rate of gas flowing through said exhaust passage to said turbine, the method further comprising decreasing a flow rate of gas flowing to said turbine by means of said flow control valve in said shutting off supplying fuel to said combustion chamber compared to in a case of supplying fuel to said combustion chamber, and decreasing the lift of said intake valve in said shutting off supplying fuel to said combustion chamber.

13. The method as described in claim 1, wherein a lift of either one of said intake and exhaust valves for said combustion chamber is decreased in said shutting off supplying fuel to said combustion chamber.

14. The method as described in claim 13, wherein the lift of said either one of said intake and exhaust valves is decreased to zero in said shutting off supplying fuel to said combustion chamber.

15. The method as described in claim 14, wherein said internal combustion engine system further has a second EGR passage which communicates said exhaust passage upstream of said turbine and said intake passage downstream of said compressor, and a second EGR control valve which is arranged in said second EGR passage and configured to control gas flow through said second EGR passage, the method further comprising increasing an opening of said second EGR control valve in said shutting off supplying fuel to said combustion chamber compared to in a case of supplying fuel to said combustion chamber, and decreasing the lift of said intake valve in said shutting off supplying fuel to said combustion chamber.

16. The method as described in claim 14, wherein the internal combustion engine system further has a flow control valve which controls flow rate of gas flowing through said exhaust passage to said turbine, the method further comprising decreasing a flow rate of gas flowing to said turbine by means of said flow control valve in said shutting off supplying fuel to said combustion chamber compared to in a case of supplying fuel to said combustion chamber, and decreasing the lift of said intake valve in said shutting off supplying fuel to said combustion chamber.

17. The method as described in claim 1, wherein the lift of said either one of said intake and exhaust valves is decreased to zero in said shutting off supplying fuel to said combustion chamber.

18. The method as described in claim 1, wherein said internal combustion engine system further has a second EGR passage which communicates said exhaust passage upstream of said turbine and said intake passage downstream of said compressor, and a second EGR control valve which is arranged in said second EGR passage and configured to control gas flow through said second EGR passage, the method further comprising increasing an opening of said second EGR control valve in said shutting off supplying fuel to said combustion chamber compared to in a case of supplying fuel to said combustion chamber, and decreasing the lift of said intake valve in said shutting off supplying fuel to said combustion chamber.

19. The method as described in claim 1, wherein the internal combustion engine system further has a flow control valve which controls flow rate of gas flowing through said exhaust passage to said turbine, the method further comprising decreasing a flow rate of gas flowing to said turbine by means of said flow control valve in said shutting off supplying fuel to said combustion chamber compared to in a case of supplying fuel to said combustion chamber, and decreasing the lift of said intake valve in said shutting off supplying fuel to said combustion chamber.

20. An internal combustion engine system comprising:
an internal combustion engine;
a valve driving mechanism which reciprocally drives intake and exhaust valves for a combustion chamber of said internal combustion engine with rotational movement of a crankshaft of said internal combustion engine;
a turbocharger consisting of a turbine which is arranged in an exhaust passage from a combustion chamber of said internal combustion engine and a compressor which is arranged in an intake passage to said combustion chamber;
an emission control device which is arranged in said exhaust passage downstream of said turbine, a first EGR passage which communicates said exhaust passage downstream of said emission control device and said intake passage upstream of said compressor; and
a controller configured to:
shut off supplying fuel to said combustion chamber under a predetermined condition; and
control said valve driving mechanism to decrease a lift of said intake or exhaust valve for said combustion chamber in said shutting off supplying fuel to said combustion chamber compared to in a case of supplying fuel to said combustion chamber.
